(19) United States
(12) Patent Application Publication
(10) Pub. No.: US 2023/0176995 A1
(43) Pub. Date: Jun. 8, 2023

(54) POWER-SAVING TECHNIQUES IN COMPUTING DEVICES THROUGH COMMUNICATION BUS CONTROL

(71) Applicant: QUALCOMM Incorporated, San Diego, CA (US)

(72) Inventors: Hongchao Guan, Shanghai (CN); Feng Jiao, Beijing (CN)

(21) Appl. No.: 18/005,437

(22) PCT Filed: Sep. 2, 2020
(86) PCT No.: PCT/CN2020/112967

§ 371 Date: Jan. 13, 2023

(51) Int. Cl. G06F 13/42

(52) U.S. Cl. CPC G06F 13/4221; G06F 2213/0026

(57) ABSTRACT

Power-saving techniques in computing devices through communication bus control start a timer when data is ready to be sent across a communication bus from a first terminus to a second terminus. While the timer is running, any data from any channel that is ready to be sent across the communication bus from the first terminus to the second terminus is accumulated. At expiration of the timer, all data is sent across the communication bus. By holding or accumulating the data in this fashion, unnecessary transitions between low-power states and active states on the communication bus are reduced and power is conserved. The timer may be set based on latency requirements of the data ready to be sent.

### PRIORITY APPLICATION

The present application is a national stage application under 35 U.S.C. 371 of International Patent Application Serial No. PCT/CN2020/112967, filed Sep. 2, 2020 and entitled “POWER-SAVING TECHNIQUES IN COMPUTING DEVICES THROUGH COMMUNICATION BUS CONTROL,” which is incorporated herein by reference in its entirety.

### BACKGROUND

### I. Field of the Disclosure

The technology of the disclosure relates generally to power-saving techniques in computing devices through communication bus control.

### II. Background

Computing devices abound in modern society. Ranging from small, mobile computing devices, such as a smart phone or tablet, to large server farms with numerous blades and memory banks, these devices are expected to communicate across myriad networks while providing various other base functions. While desktop devices and servers are generally immune to concerns about power consumption, mobile devices constantly struggle to find a proper balance between available functions and battery life. That is, as more functions are provided, power consumption increases, and battery life is shortened. Servers may likewise have power consumption concerns when assembled in large server farms. Accordingly, there is always room to secure power savings.

### SUMMARY OF THE DISCLOSURE

Aspects disclosed in the detailed description include power-saving techniques in computing devices through communication bus control. In particular, when data is ready to be sent across a communication bus from a first terminus to a second terminus, a timer is started. While the timer is running, any data from any channel that is ready to be sent across the communication bus from the first terminus to the second terminus is accumulated. At expiration of the timer, all data is sent across the communication bus. By holding or accumulating the data in this fashion, unnecessary transitions between low-power states and active states on the communication bus are reduced and power is conserved. The timer may be set based on latency requirements of the data ready to be sent.

In this regard in one aspect, an integrated circuit (IC) is disclosed. The IC includes a timer. The IC also includes at least one data source circuit. The IC also includes an interconnectivity bus interface. The IC also includes a control circuit. The control circuit is configured to receive an indication that the at least one data source circuit has data or a command to send to a second IC. The control circuit is also configured to start the timer on receipt of the indication. The control circuit is also configured to accumulate data across plural channels until expiration of the timer. The control circuit is also configured to send the accumulated data at the expiration of the timer over the interconnectivity bus interface to the second IC.

In another aspect, a communication system is disclosed. The communication system includes an interconnectivity bus. The communication system also includes a first IC. The first IC includes a first timer. The first IC also includes at least one first data source circuit. The first IC also includes a first interconnectivity bus interface coupled to the interconnectivity bus. The first IC also includes a first control circuit. The first control circuit is configured to receive an indication that the at least one first data source circuit has first data to send to a second IC. The first control circuit is also configured to start the first timer on receipt of the indication. The first control circuit is also configured to accumulate data across plural channels until expiration of the first timer. The first control circuit is also configured to send the accumulated data at the expiration of the first timer over the first interconnectivity bus interface to the second IC. The communication system also includes the second IC. The second IC includes a second interconnectivity bus interface coupled to the interconnectivity bus. The second IC also includes a second control circuit. The second control circuit is configured to receive the accumulated data. The second control circuit is also configured, responsive to initially receiving the accumulated data, to begin sending second data to the first IC.

In another aspect, a method of controlling an interconnectivity bus is disclosed. The method includes receiving an indication that at least one first data source circuit has first data to send to a remote IC through the interconnectivity bus. The method also includes starting a first timer on receipt of the indication. The method also includes accumulating data across plural channels until expiration of the first timer. The method also includes sending the accumulated data at the expiration of the first timer over an interconnectivity bus interface to the remote IC.

### BRIEF DESCRIPTION OF THE FIGURES

FIG. 1A is a simplified view of a computing device operating with remote networks;

FIG. 1B is a simplified view of a mobile terminal operating with remote networks;

FIG. 1C is an expanded block diagram view of the mobile terminal of FIG. 1B with an internal interconnectivity bus illustrated;

FIG. 1D is a block diagram of the mobile terminal of FIG. 1B;

FIG. 2 is a diagram of a protocol stack that may be sent of an internal interconnectivity bus and where channels may arise from within the protocol stack;

FIG. 3A is an exemplary time versus link power graph in a conventional computing device for a single channel;

FIG. 3B is an exemplary time versus link power graph in a conventional computing device for a plurality of channels;

FIG. 4 is a block diagram of a Peripheral Component Interconnect (PCI) Express (PCIE) system within a computing device that may benefit from the power-saving techniques of the present disclosure;

FIG. 5 is a block diagram of an application processor having a PCIE root complex circuit therein;

FIG. 6 is a block diagram of a modem having a PCIE endpoint circuit therein;

FIG. 7A is a flowchart illustrating an exemplary process for reducing power consumption through communication bus control;

FIG. 7B is a second flowchart illustrating more explicitly decision points in the process of FIG. 7A;

FIG. 8 is a time versus link power graph for a PCIE system operating according to an exemplary aspect of the present disclosure; and

FIG. 9 is a block diagram of an exemplary processor-based system that can include PCIE systems such as the PCIE system of FIG. 4 that include the power-reduction processes of FIGS. 7A and 7B.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include power-saving techniques in computing devices through communication bus control. In particular, when data is ready to be sent across a communication bus from a first terminus to a second terminus, a timer is started. While the timer is running, any data from any channel that is ready to be sent across the communication bus from the first terminus to the second terminus is accumulated. At expiration of the timer, all data is sent across the communication bus. By holding or accumulating the data in this fashion, unnecessary transitions between low-power states and active states on the communication bus are reduced and power is conserved. The timer may be set based on latency requirements of the data ready to be sent.

In a particularly contemplated aspect, the present disclosure is suited for use by a Peripheral Component Interconnect (PCI) Express (PCIE) system within a mobile terminal. By aggregating or consolidating all channels on a PCIE link, the termini of the link may remain in low-power modes for longer periods of time, and less power is spent entering and exiting low-power modes.

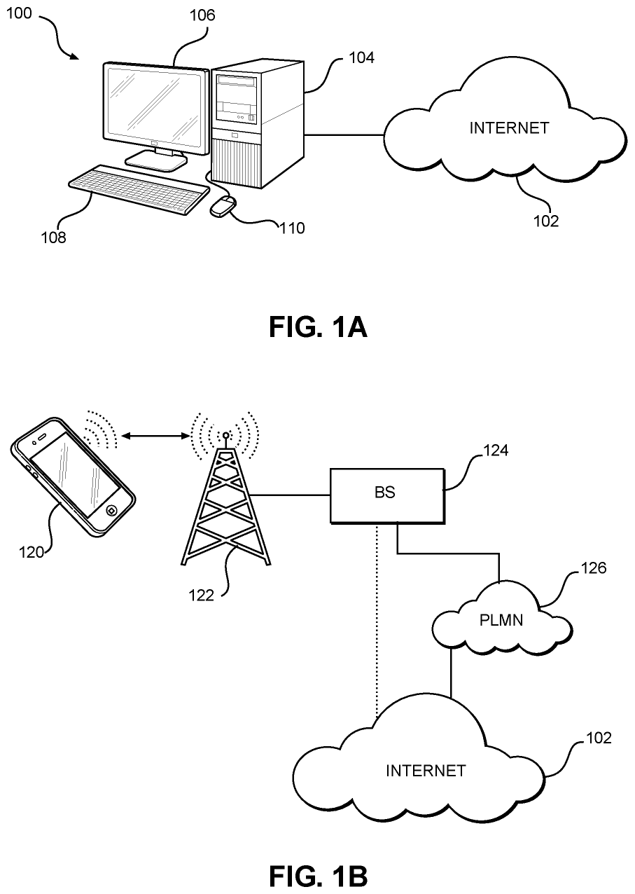

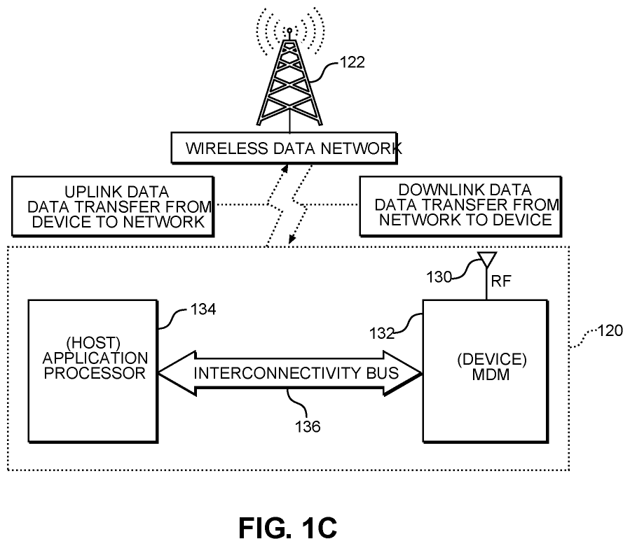

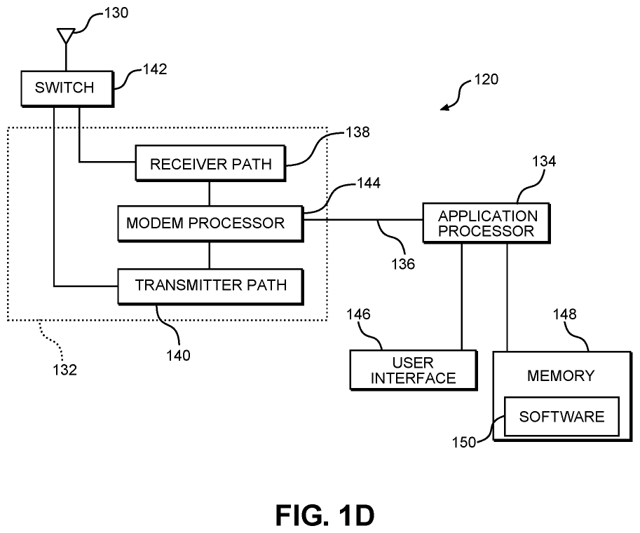

While it is contemplated that the power-saving techniques of the present disclosure are used in PCIE links in mobile terminals, such as smart phones or tablets, the present disclosure is not so limited. Accordingly, FIGS. 1A and 1B illustrate computing devices coupled to remote networks via modems that may implement exemplary aspects of the power-saving techniques of the present disclosure, while FIGS. 1C and 1D provide additional details about internal communication links for the modems to other processors within the computing device. In this regard, FIG. 1A illustrates a computing device 100 coupled to a network 102, which, in an exemplary aspect, is the internet. The computing device 100 may include a housing 104 with a central processing unit (CPU) (not illustrated) therein. A user may interact with the computing device 100 through a user interface formed from input/output elements such as a monitor 106 (sometimes referred to as a display), a keyboard 108, and/or a mouse 110. In some aspects, the monitor 106 may be incorporated into the housing 104. While the keyboard 108 and mouse 110 are illustrated as input devices, the monitor 106 may be a touchscreen display, which may supplement or replace the keyboard 108 and mouse 110 as an input device. Other input/output devices may also be present as is well understood in conjunction with desktop or laptop style computing devices. While not illustrated in FIG. 1A, the housing 104 may also include a modem therein. The modem may be positioned on a network interface card (NIC), as is well understood. Likewise, a router and/or an additional modem may be external to the housing 104. For example, the computing device 100 may couple to the network 102 through a router and a cable modem, as is well understood. However, even where such external routers and modems are present, the computing device 100 is likely to have an internal modem to effectuate communication with such external routers and modems.

In addition to the computing device 100, exemplary aspects of the present disclosure may also be implemented on a mobile terminal, which is a form of computing device as that term is used herein. In this regard, an exemplary aspect of a mobile terminal 120 is illustrated in FIG. 1B. Instead of a smart phone, the mobile terminal 120 may be a cellular telephone, a tablet, a laptop, or other mobile computing device. The mobile terminal 120 may communicate with a remote antenna 122 associated with a base station (BS) 124. The BS 124 may communicate with the public land mobile network (PLMN) 126, the public switched telephone network (PSTN, not shown), or a network 102 (e.g., the internet). It is also possible that the PLMN 126 communicates with the internet (e.g., the network 102) either directly or through an intervening network (e.g., the PSTN). It should be appreciated that most contemporary mobile terminals 120 allow for various types of communication with elements of the network 102. For example, streaming audio, streaming video, and/or web browsing are all common functions on most contemporary mobile terminals 120. Such functions are enabled through applications stored in the memory of the mobile terminal 120 and using the wireless transceiver of the mobile terminal 120.

To effectuate functions, such as streaming video, data arrives from the remote antenna 122 at an antenna 130 of the mobile terminal 120, as illustrated in FIG. 1C. The data is initially processed at a mobile device modem (MDM) 132 of the mobile terminal 120 and passed to an application processor 134 by an interconnectivity bus 136. In this context, the application processor 134 is generally an integrated circuit (IC) and may be a host, and the MDM 132 is likewise an IC and may be a device as those terms are used in the PCIE standard. While exemplary aspects contemplate operating over a PCIE-compliant interconnectivity bus 136, it is possible that the interconnectivity bus 136 may comply with High Speed Interconnect (HSIC), Universal Asynchronous Receiver/Transmitter (UART), universal serial bus (USB), or the like.

A more detailed depiction of some of the components of the mobile terminal 120 is provided with reference to FIG. 1D. The mobile terminal 120 may include a receiver path 138, a transmitter path 140, the antenna 130 (mentioned above with reference to FIG. 1C), a switch 142, a modem processor 144, and the application processor 134 (also introduced above in reference to FIG. 1C). Optionally, a separate control circuit (not shown) may also be present with a CPU as is well understood. The application processor 134 and the modem processor 144 are connected by the interconnectivity bus 136. The application processor 134 and/or the control circuit (if present) may interoperate with a user interface 146 and memory 148 with software 150 stored therein.

The receiver path 138 receives information bearing radio frequency (RF) signals from one or more remote transmitters provided by a base station (e.g., the BS 124 of FIG. 1B). A low noise amplifier (not shown) amplifies the signal. A filter (not shown) minimizes broadband interference in the received signal. Downconversion and digitization circuitry (not shown) downconverts the filtered, received signal to an intermediate or baseband frequency signal. The baseband frequency signal is then digitized into one or more digital streams. The receiver path 138 typically uses one or more mixing frequencies generated by a frequency synthesizer. The modem processor 144 may include a baseband processor (BBP) (not shown) that processes the digitized received signal to extract the information or data bits conveyed in the signal. As such, the BBP is typically implemented in one or more digital signal processors (DSPs) within the modem processor 144 or as a separate IC as needed or desired. In an exemplary aspect, the receiver path 138 may include a data source circuit that is responsible for incoming data from the remote network. Additionally, there may be circuits (not shown) within the modem processor 144 that act as data source circuits. For example, a control circuit may generate control data, BIOS data, or the like to send to the application processor 134.

With continued reference to FIG. 1D, on the transmit side, the modem processor 144 receives digitized data, which may represent voice, data, or control information, from the application processor 134, which it encodes for transmission. The encoded data is output to the transmitter path 140, where it is used by a modulator (not shown) to modulate a carrier signal at a desired transmit frequency. An RF power amplifier (not shown) amplifies the modulated carrier signal to a level appropriate for transmission, and delivers the amplified and modulated carrier signal to the antenna 130 through the switch 142. Collectively, the modem processor 144, the receiver path 138, and the transmitter path 140 form the MDM 132 of FIG. 1C (sometimes also referred to as a wireless modem). While the MDM 132 is specifically described with relation to the RF signals associated with a cellular signal such as those provided under 5G, the present disclosure is not so limited. For example, a wireless modem using other wireless protocols may also benefit from inclusion of aspects of the present disclosure. Thus, modems operating according to standards such as BLUETOOTH®, the various IEEE 802.11 standards, Universal Mobile Telecommunications System (UMTS), High Speed Packet Access (HSPA), Long Term Evolution (LTE), and other wireless protocols may all use aspects of the present disclosure.

With continued reference to FIG. 1D, a user may interact with the mobile terminal 120 via the user interface 146, such as a microphone, a speaker, a keypad, and a display. Audio information encoded in the received signal is recovered by the BBP, and converted into an analog signal suitable for driving the speaker. The keypad and display enable the user to interact with the mobile terminal 120. For example, the keypad and display may enable the user to input numbers to be dialed, access address book information, or the like, as well as monitor call progress information. The memory 148 may have the software 150 therein as noted above, which may effectuate exemplary aspects of the present disclosure.

In conventional mobile terminals that have a PCIE interconnectivity bus (i.e., the interconnectivity bus 136), the PCIE standard allows the interconnectivity bus 136 to be placed into a sleep or low-power mode. While placing the interconnectivity bus 136 in a sleep or low-power mode generally saves power, such sleep modes do have a drawback in that they consume relatively large amounts of power as they transition out of the sleep mode. This power consumption is exacerbated because of the asynchronous nature of the PCIE interconnectivity bus 136. That is, first data may arrive at the modem processor 144 for transmission to the application processor 134 at a time different than when second data is ready to pass from the application processor 134 to the modem processor 144. This problem is not unique to the PCIE interconnectivity bus 136. Further, this data may be present in different channels within the interconnectivity bus 136.

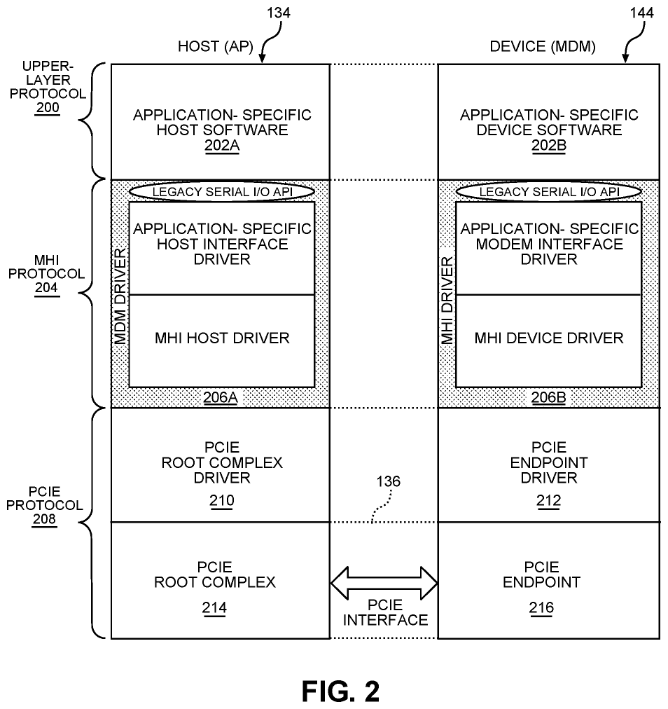

FIG. 2 illustrates protocol stacks that may exist in the application processor 134 and the modem processor 144 to provide a general overview of the different sorts of channels and data source circuits that may exist. In particular, there may be an upper layer protocol 200 where respective application-specific software 202A and 202B operate. Below that in the protocol stack is a modem host interface (MHI) protocol layer 204 where drivers 206A and 206B operate. Below that in the protocol stack is a PCIE-specific protocol layer 208 with a root complex driver 210 and an endpoint driver 212 that send and receive signals through respective bus interfaces 214, 216 over the bus 136. Circuits may exist at each level of the protocol stacks that act as data source circuits that generate data to be sent to the other terminus (e.g., application processor 134 to modem processor 144 or vice versa).

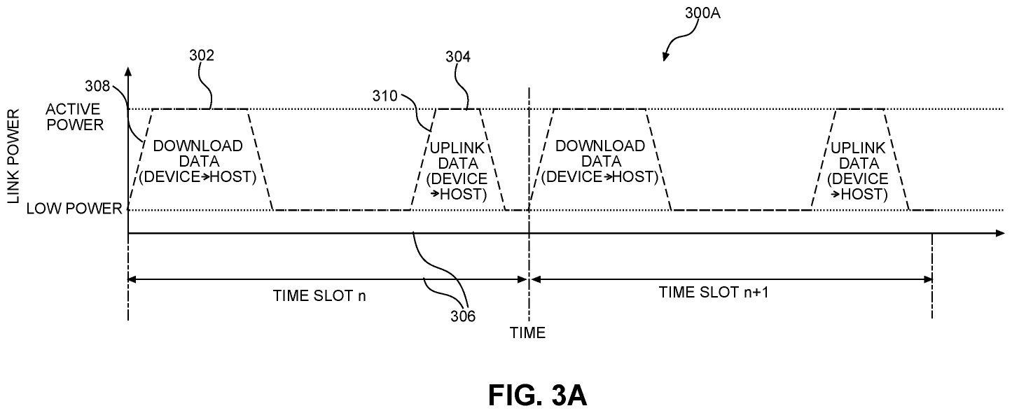

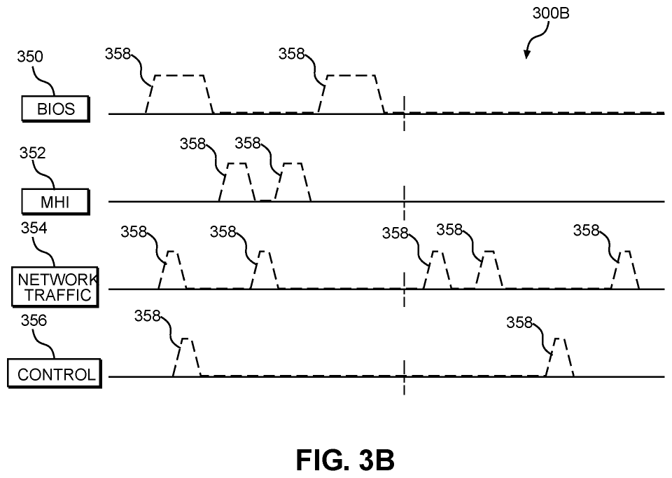

FIG. 3A illustrates a time versus link (e.g., PCIE link) power graph 300A that highlights how downlink data 302 may have a different transmission time than uplink data 304 for a given channel within a given time slot 306. In particular, the interconnectivity bus 136 (FIG. 1C or 1D) begins in a sleep or low-power mode and transitions up to an active power state by transition 308 so that the downlink data 302 may be transmitted to the application processor 134. However, the downlink data 302 may not occupy the entirety of the time slot 306, and the interconnectivity bus 136 may return to a low-power state. However, subsequently, but still within the same time slot 306, the uplink data 304 from the application processor 134 is sent to the modem processor 144. Accordingly, the interconnectivity bus 136 is again transitioned from the low-power state to the active power state by a second transition 310. In an exemplary aspect, the time slot 306 is approximately one millisecond (1 ms) long. Thus, if two transitions (i.e., 308, 310) from low power to active power occur every time slot 306, then thousands of transitions 308, 310 occur every second. Thousands of transitions 308, 310 consume substantial amounts of power and reduce the battery life of the mobile terminal 120.

The number of transitions within a single second may be even worse than projected by the graph 300A because the graph 300A represents only a single channel over the interconnectivity bus 136. If the interconnectivity bus 136 is a PCIE bus, there may be many channels as illustrated by the time versus link power graph 300B in FIG. 3B. For example, there may be a BIOS channel 350, an MHI channel 352, a network traffic channel 354, and/or a control channel 356. Each channel 350, 352, 354, 356 may have its respective rising transitions 358 for uplink and downlink data with intermediate low-power windows. The cumulative number of transitions 358 creates an even greater drain on the battery life of the mobile terminal 120.

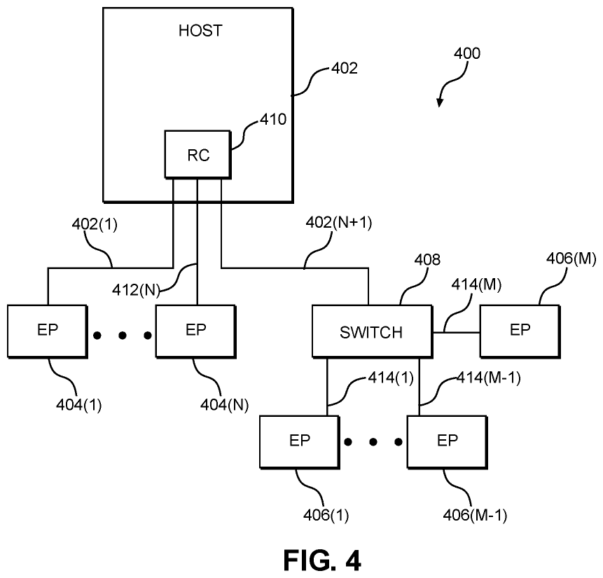

Exemplary aspects of the present disclosure help reduce the number of transitions on an interconnectivity bus by consolidating or aggregating data across all channels from the various data source circuits and sending the aggregated data in a single active window, thereby allowing the termini of the bus to remain in low-power states longer and with fewer interruptions. Before providing details on this consolidation, a more detailed review of a PCIE system is provided with reference to FIGS. 4-6.

In this regard, FIG. 4 illustrates a computing environment 400 with a host 402 coupled to a plurality of devices 404(1)-404(N) directly and to a second plurality of devices 406(1)-406(M) through a switch 408. The host 402 may include a PCIE root complex (RC) 410 that includes a bus interface (not illustrated directly) that is configured to couple to plural PCIE buses 412(1)-412(N+1). The switch 408 communicates to the devices 406(1)-406(M) through PCIE buses 414(1)-414(M). The devices 404(1)-404(N) and 406(1)-406(M) may be or may include PCIE endpoints. In a first exemplary aspect, the computing environment 400 may be a single computing device such as a computer with the host 402 being a CPU and the devices 404(1)-404(N) and 406(1)-406(M) being internal components such as hard drives, disk drives, or the like. In a second exemplary aspect, the computing environment 400 may be a computing device where the host 402 is an IC on a board and the devices 404(1)-404(N) and 406(1)-406(M) are other ICs within the computing device. In a third exemplary aspect, the computing environment 400 may be a computing device having an internal host 402 coupled to external devices 404(1)-404(N) and 406(1)-406(M) such as a server coupled to one or more external memory drives. Note that these aspects are not necessarily mutually exclusive in that different ones of the devices may be ICs, internal, or external relative to a single host 402.

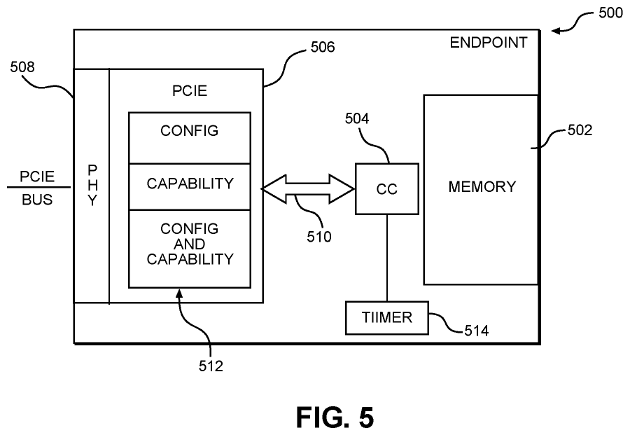

FIG. 5 provides a block diagram of a device 500 that may be one of the devices 404(1)-404(N) or the devices 406(1)-406(M). In particular, the device 500 acts as an endpoint in a PCIE system, and may be, for example, a memory device that includes a memory element 502 and a control circuit 504. Further, the device 500 includes a PCIE hardware element 506 that includes a bus interface configured to couple to a PCIE bus. The PCIE hardware element 506 may include a physical layer (PHY) 508 that is, or works with, the bus interface to communicate over the PCIE bus. The control circuit 504 communicates with the PCIE hardware element 506 through a system bus 510. The PCIE hardware element 506 may further include a plurality of registers 512. The registers 512 may be conceptually separated into configuration registers and capability registers. Additionally, the control circuit 504 may work with a timer 514 to effectuate aspects of the present disclosure.

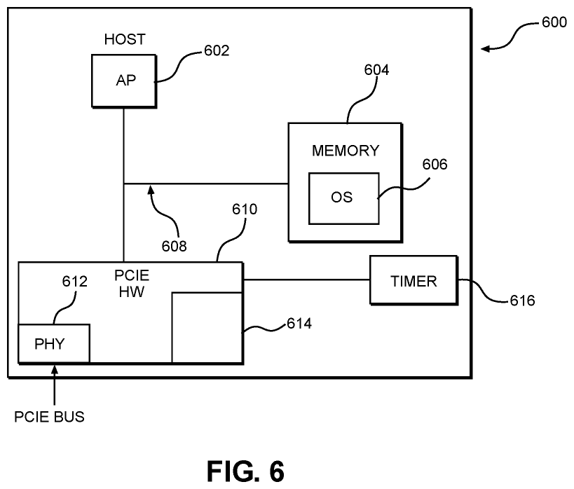

Similarly, FIG. 6 illustrates a host 600 which may be the host 402 of FIG. 4. The host 600 may include an application processor 602 or other processor core which communicates with a memory element 604 having an operating system 606 operating therewith. A system bus 608 interconnects the application processor 602 with the memory element 604 and a PCIE hardware (HW) or PCIE RC 610. The PCIE RC 610 may include a PHY 612 that works with or is a bus interface configured to couple to a PCIE bus. The PCIE RC 610 further includes a plurality of registers 614 that track configuration and capabilities of connected endpoints. The application processor 602 or the PCIE RC 610 may work with a timer 616 according to exemplary aspects of the present disclosure.

It should be appreciated that both the device 500 and the host 600 may have plural data source circuits therein. For example, the transmit path (not illustrated) may be a data source circuit within the device 500 and may be the control circuit 504 or the actual PHY 508. Similarly, the host 600 may have multiple data source circuits therein. For example, a transmit path (not illustrated) that is sending data to the modem to be sent out to the remote network may be a data source circuit and may be a control circuit, the actual PHY 612, or the like. Each of these data source circuits may have a dedicated channel within the PCIE link or may share a channel with another data source circuit (e.g., all data source circuits in the MHI layer of the protocol stack may share a channel).

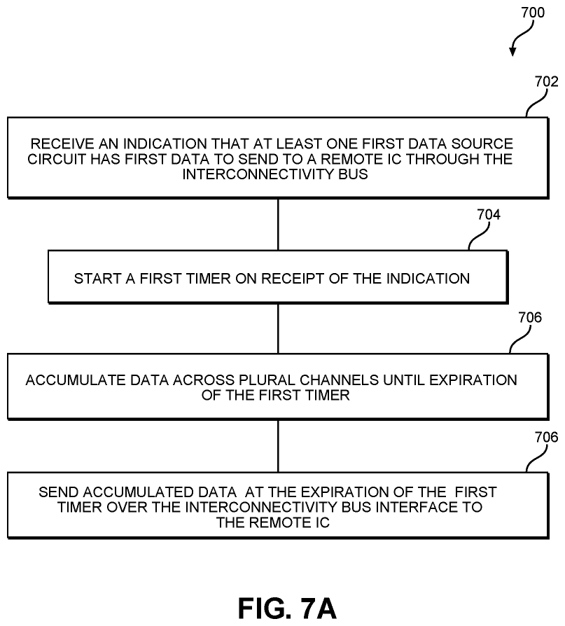

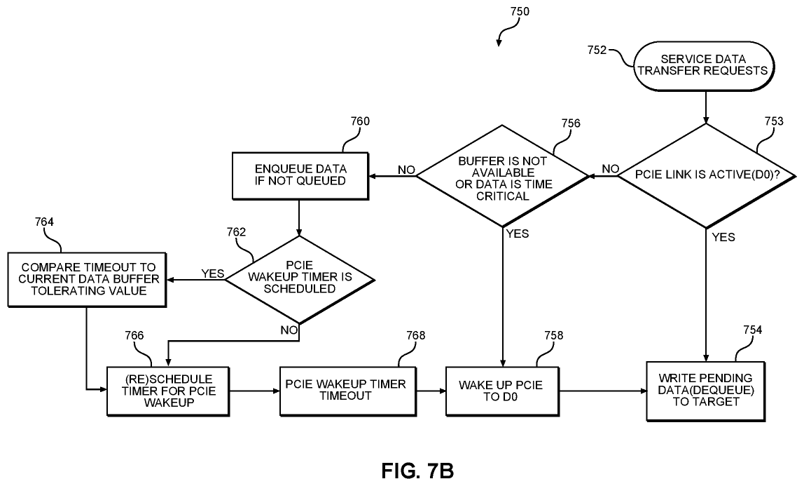

A high-level flowchart of a process of signal accumulation is provided in FIG. 7A with reference to process 700. In particular, the process 700 begins by receiving an indication that at least one first data source circuit has first data to send to a remote IC through the interconnectivity bus (block 702). For example, if the modem processor receives data from the remote network, the transmit path may indicate that there is data to send to the application processor through the PCIE bus. The process 700 continues by starting a first timer on receipt of the indication (block 704). Continuing this example, the first timer is in the modem processor and is started on receipt of the data from the remote network. The process 700 continues by accumulating data across plural channels until expiration of the first timer (block 706). That is, any additional data or commands generated within the modem are accumulated with the data from the remote network while the timer is running. The process 700 continues by sending the accumulated data at the expiration of the first timer over the interconnectivity bus interface to the remote IC (block 708). All data across all channels that has been accumulated while the timer is running is sent to the application processor. As the data is sent as an accumulated burst, there are fewer transitions from low power on the PCIE bus, and the termini are allowed to remain in low-power states for longer times. The reduction in transitions reduces power consumption. It should be noted that once the data begins flowing from the modem to the application processor, the application processor may respond with data being held or accumulated at the application processor. In a first aspect, the application processor sends data to the initiating modem processor. In a second aspect, having exited a low-power state, the application processor sends any pending data to any possible endpoint (e.g., all of the devices 404(1)-404(N) and the devices 406(1)-406(M). By sending all the pending data, the application processor maximizes the productivity of the active state and may prevent a subsequent exit and entry from the low-power state. The data may be interleaved with the data from the modem or sent after the modem has finished transmitting but before a transition to a low-power state.

A more detailed explanation of the power saving through communication bus control process is provided by process 750 set forth in FIG. 7B. Specifically, there is some service data transfer request (block 752). That is, a data source circuit has provided an indication that there is data or a command to be transferred. The control circuit that has received the data transfer request determines if a PCIE link is active (i.e., in state D0) (block 753). If the answer to block 753 is yes, the PCIE link is active, then the data is sent by writing the pending data (e.g., dequeue) to the target (block 754). That is, the data or command is sent over the PCIE link to the remote IC. If however, the answer to block 753 is no, the PCIE link is not active (e.g., the PCIE link is in a low-power or sleep mode), then the control circuit determines if a buffer is not available or the data is time critical (block 756). If the answer to either inquiry in block 756 is yes, then the control circuit wakes the PCIE link to D0 (block 758) and the data is written (block 754).

If, however, the answer to block 756 is no, (i.e., there is buffer space and the data is not time critical), the control circuit enqueues the data if there is not already a queue (block 760). Further, the control circuit determines if there is an active PCIE wakeup timer already scheduled (i.e., operating) (block 762). If the answer to block 762 is yes, then the control circuit compares a timeout value associated with the current data to the buffer tolerating value (block 764). That is, does the new data have a latency requirement shorter than the amount of time left on the currently-running timer. If the answer is no, then the data is merely accumulated with the previous data and sent with the previous data. If, however, the new data has a shorter latency (or there is no previous data from block 762), then the control circuit schedules (or adjusts/reschedules) the timer to wake up the PCIE link (block 766).

With continued reference to FIG. 7B, at timer timeout, the PCIE link wakeup is initiated (block 768), the PCIE link wakes (block 758), and data is sent (block 754).

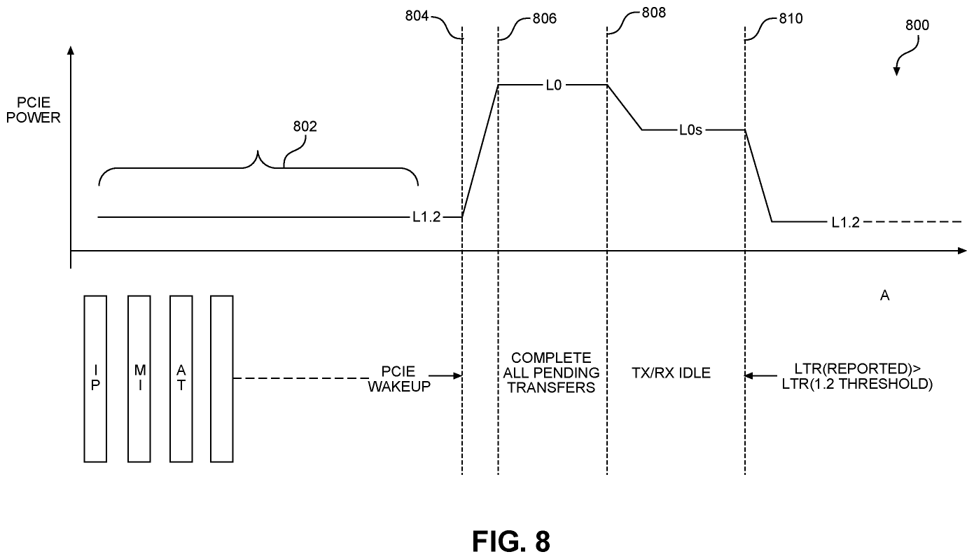

The net result of the accumulation of data according to exemplary aspects of the present disclosure is presented as a time versus link power graph 800 in FIG. 8, where initially, data is accumulated (e.g., enqueued) while the PCIE link remains in a low-power state (e.g., L1.2) (generally time window 802). At time 804, the timer has expired, and the PCIE link wakes up to an active state beginning at time 806. While in the active state, all pending data is transferred. At time 808, the data has completed transfer and after a period of inactivity, the PCIE link transitions to a lower-power state (e.g., L0s). After being idle until time 810, the PCIE link returns to the low-power state L1.2. A latency tolerance report (LTR) is reported and updated.

The LTR is defined in section 6.18 of the PCIE specification specifically stating: The LTR “mechanism enables Endpoints to report their service latency requirements for Memory Reads and Writes to the Root Complex, so that power management policies for central platform resources (such as main memory, RC internal interconnects, and snoop resources) can be implemented to consider Endpoint service requirements.”

Exemplary aspects of the present disclosure allow a PCIE endpoint (e.g., device 500) to transmit an LTR message to the host or root complex (e.g., host 600) according to a few guidelines. In particular, an acceptable latency indicated by the LTR message from the PCIE endpoint is the lowest tolerated latency value associated with all PCIE MHI channels or services. The latency value, in an exemplary aspect, may generally be between tens of milliseconds to hundreds of milliseconds per MHI channel. Conversely, the low-power state threshold (e.g., L1.2 threshold) may be hundreds of microseconds. Thus, it is enough for the PCIE link to enter low-power mode L1.2 when the CLKREQ# is deasserted. In an exemplary aspect, the LTR message may be sent after all transfers of data to the root complex are complete. Alternatively, the LTR message may be sent on power-up initialization. Sending after the data transfer may be appropriate if there is a change to the lowest tolerated latency value for an MHI channel.

Responsive to the LTR report, the host 600 may schedule appropriate timers for wakeup on MHI transfers. In particular, the timeout setting should be no longer than the LTR value reported from the endpoint to help guarantee all endpoint service latency limitations are met.

The power-saving techniques in computing devices through communication bus control according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

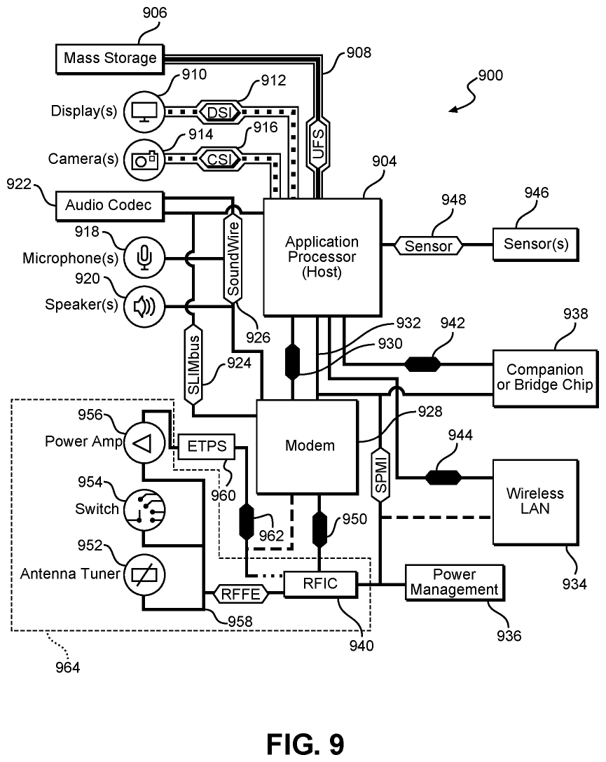

More generally, FIG. 9 is a system-level block diagram of an exemplary mobile terminal 900 such as a smart phone, mobile computing device tablet, or the like. While a mobile terminal having a PCIE bus is particularly contemplated as being capable of benefiting from exemplary aspects of the present disclosure, it should be appreciated that the present disclosure is not so limited and may be useful in any system having an interconnectivity bus.

With continued reference to FIG. 9, the mobile terminal 900 includes an application processor 904 (sometimes referred to as a host) that communicates with a mass storage element 906 through a universal flash storage (UFS) bus 908. The application processor 904 may further be connected to a display 910 through a display serial interface (DSI) bus 912 and a camera 914 through a camera serial interface (CSI) bus 916. Various audio elements such as a microphone 918, a speaker 920, and an audio codec 922 may be coupled to the application processor 904 through a serial low-power interchip multimedia bus (SLIMbus) 924. Additionally, the audio elements may communicate with each other through a SOUNDWIRE bus 926. A modem 928 may also be coupled to the SLIMbus 924 and/or the SOUNDWIRE bus 926. The modem 928 may further be connected to the application processor 904 through a PCI or PCIE bus 930 and/or a system power management interface (SPMI) bus 932.

With continued reference to FIG. 9, the SPMI bus 932 may also be coupled to a local area network (LAN or WLAN) IC (LAN IC or WLAN IC) 934, a power management integrated circuit (PMIC) 936, a companion IC (sometimes referred to as a bridge chip) 938, and a radio frequency IC (RFIC) 940. It should be appreciated that separate PCI buses 942 and 944 may also couple the application processor 904 to the companion IC 938 and the WLAN IC 934. The application processor 904 may further be connected to sensors 946 through a sensor bus 948. The modem 928 and the RFIC 940 may communicate using a bus 950.

With continued reference to FIG. 9, the RFIC 940 may couple to one or more RFFE elements, such as an antenna tuner 952, a switch 954, and a power amplifier 956 through a radio frequency front end (RFFE) bus 958. Additionally, the RFIC 940 may couple to an envelope tracking power supply (ETPS) 960 through a bus 962, and the ETPS 960 may communicate with the power amplifier 956. Collectively, the RFFE elements, including the RFIC 940, may be considered an RFFE system 964. It should be appreciated that the RFFE bus 958 may be formed from a clock line and a data line (not illustrated).

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The devices described herein may be employed in any circuit, hardware component, IC, or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

What is claimed is:

1. An integrated circuit (IC) comprising:
a timer;
at least one data source circuit;
an interconnectivity bus interface; and
a control circuit configured to:
receive an indication that the at least one data source circuit has data or a command to send to a second IC;
start the timer on receipt of the indication;
accumulate data across plural channels until expiration of the timer; and
send the accumulated data at the expiration of the timer over the interconnectivity bus interface to the second IC.

2. The IC of claim 1, wherein the IC comprises a modem and the second IC comprises an application processor.

3. The IC of claim 2, wherein the at least one data source circuit comprises a wireless transceiver.

4. The IC of claim 1, wherein the IC comprises an application processor and the second IC comprises a modem.

5. The IC of claim 1, wherein the interconnectivity bus interface comprises a Peripheral Component Interconnect (PCI) Express (PCIE) bus interface.

6. The IC of claim 1, wherein the at least one data source circuit comprises one of: a BIOS circuit, a modem hardware interface (MHI) circuit, or a packet creation circuit.

7. The IC of claim 1, wherein the plural channels comprise at least two of: a control channel, an MHI control channel, a BIOS channel, and a network traffic channel.

8. The IC of claim 1, further comprising a buffer and wherein the control circuit is configured to send the accumulated data responsive to the buffer being full.

9. The IC of claim 1, wherein the control circuit is configured to turn off the timer after sending the accumulated data.

10. The IC of claim 1, wherein the control circuit is further configured to select an amount of time for the timer based on a first latency requirement associated with a channel associated with the at least one data source circuit.

11. The IC of claim 10, wherein the control circuit is further configured to:
receive a second indication that a second data source circuit has second data to send to the second IC, wherein the second data has a second latency requirement shorter than the first latency requirement; and
adjust the timer based on the second latency requirement.

12. The IC of claim 1, wherein the control circuit is configured to start the timer with a timer duration exceeding a single time slot of any of the plural channels.

13. The IC of claim 1, wherein the control circuit is configured to:
calculate a latency tolerance report (LTR) based on a lowest tolerated latency value; and
send an LTR update to the second IC.

14. The IC of claim 1, wherein the control circuit is further configured to receive second data from the second IC during or after sending the accumulated data.

15. The IC of claim 1 integrated into a device selected from the group consisting of:
a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

16. A communication system comprising:
an interconnectivity bus;
a first integrated circuit (IC) comprising:
a first timer;
at least one first data source circuit;
a first interconnectivity bus interface coupled to the interconnectivity bus; and
a first control circuit configured to:
receive an indication that the at least one first data source circuit has first data to send to a second IC;
start the first timer on receipt of the indication;
accumulate data across plural channels until expiration of the first timer; and
send the accumulated data at the expiration of the first timer over the first interconnectivity bus interface to the second IC; and
the second IC comprising:
a second interconnectivity bus interface coupled to the interconnectivity bus; and
a second control circuit configured to:
receive the accumulated data; and
responsive to initially receiving the accumulated data, begin sending second data to the first IC.

17. The communication system of claim 16, wherein the interconnectivity bus comprises a Peripheral Component Interconnect (PCI) Express (PCIE) bus.

18. The communication system of claim 16, wherein the first IC comprises a modem.

19. The communication system of claim 18, wherein the second IC comprises an application processor.

20. The communication system of claim 16, wherein the first IC further comprises a buffer and the first control circuit is configured to send the accumulated data responsive to the buffer being full.

21. The communication system of claim 16, wherein the second IC further comprises a second timer.

22. The communication system of claim 21, wherein the second control circuit is further configured to:
receive a second indication that there is second data to send to the first IC;
start the second timer on receipt of the second indication; and
send the second data at the expiration of the second timer over the second interconnectivity bus interface to the first IC.

23. The communication system of claim 16, wherein the second control circuit is further configured to, responsive to initially receiving the accumulated data, begin sending additional data to a plurality of other ICs.

24. The communication system of claim 16, wherein the first control circuit is further configured to:
calculate a latency tolerance report (LTR) based on a lowest tolerated latency value; and
send an LTR update to the second IC.

25. The communication system of claim 24, wherein the first control circuit is configured to send the LTR update after sending the accumulated data.

26. The communication system of claim 24, wherein the second control circuit is configured to set the first timer based on the LTR update.

27. A method of controlling an interconnectivity bus, comprising:
receiving an indication that at least one first data source circuit has first data to send to a remote integrated circuit (IC) through the interconnectivity bus;
starting a first timer on receipt of the indication;
accumulating data across plural channels until expiration of the first timer; and
sending the accumulated data at the expiration of the first timer over an interconnectivity bus interface to the remote IC.
